(19) United States
(12) Patent Application Publication
(10) Pub. No.: US 2026/0017166 A1
(43) Pub. Date: Jan. 15, 2026

(54) MANAGEMENT METHOD FOR STORAGE SYSTEM AND MANAGEMENT SYSTEM

(71) Applicant: Hitachi Vantara, Ltd., Yokohama-shi (JP)

(72) Inventors: Hidenori SAKANIWA, Tokyo (JP); Atsumi TERAYAMA, Tokyo (JP); Tsukasa SHIBAYAMA, Tokyo (JP)

(21) Appl. No.: 19/077,331

(22) Filed: Mar. 12, 2025

(30) Foreign Application Priority Data
Jul. 10, 2024 (JP) 2024-111326

(51) Int. Cl. G06F 11/34; G06F 9/54

(52) U.S. Cl. CPC G06F 11/3452; G06F 9/54; G06F 11/3419

(57) ABSTRACT

The prediction accuracy of required lengths of time for management operations to be performed in a storage system in response to operation requests made via a communication network from an API for management operations is improved. A management system of the storage system calculates a prediction value of a required length of time by an analytical model, which is a model of an ideal operation performed in response to an operation request for an API, calculates a prediction value of the required length of time by a statistical model, which is a model constructed on the basis of statistics of history of an operation performed in response to the operation request for the API, and determines a prediction value of the required length of time from those prediction values and weights of those models.

### CROSS-REFERENCE TO RELATED APPLICATION

The present application claims priority from Japanese application JP2024-111326, filed on Jul. 10, 2024, the content of which is hereby incorporated by reference into this application.

### BACKGROUND OF THE INVENTION

### 1. Field of the Invention

The present invention generally relates to management of storage systems, for example, to a technology for predicting required lengths of time for management operations to be performed on a storage system by utilizing an application programming interface (API) from a client.

### 2. Description of the Related Art

In recent years, storage systems on infrastructure-as-a-service (IaaS) clouds have been utilized as storage locations for daily business data and as recovery destinations for systems in case of disasters. Regarding cloud storage systems, in general, an API is utilized to manage the resource configuration of a storage system on a cloud via a communication network from a client in a remote location. As such operations that can be performed by utilizing APIs, there are management operations as at least some of operations other than input/output (I/O) operations (typically, input and output of user data with respect to volumes). The management operation includes reference operations for acquiring configuration information on targets and configuration operations for changing the configurations of targets. While many reference operations are executed synchronously (requested operations are completed in a short time), configuration operations are often executed asynchronously (it often takes time for requested configuration changes to be actually reflected). When configuration operations target resources of a storage system, for example, configuration change operations such as volume creation, path creation between volumes and hosts, snapshot creation, and replication creation can be performed as examples of configuration operations. Through the configuration operations, for example, configurations for remote copying (for example, volume pairs and paths) can be constructed in the storage system.

Among configuration operations to be executed through APIs, there are high-load ones such as processing involving many resource configuration changes and volume deletion. Moreover, lengths of processing time taken for configuration operations change significantly depending on the configurations of communication networks and the congestion levels of servers through which the APIs pass, in some cases. In this manner, the lengths of processing time required particularly for configuration operations related to resource configuration changes utilizing APIs via networks depend on various factors and are difficult to predict.

Furthermore, because storage systems prioritize I/O operations (prioritize processing in response to I/O requests for volumes), few resources are allocated to management, and therefore, a problem of insufficient performance of management operations such as configuration operations may arise.

As a technology for predicting lengths of processing time by APIs, there is a technology disclosed in JP-2018-081431-A. According to JP-2018-081431-A, configuration change processing operations executed by an API on a client side are requested, the length of processing time taken for the completion of that processing is managed as an actual value, and the length of processing time is predicted on the basis of the actual value.

### SUMMARY OF THE INVENTION

According to the technology disclosed in JP-2018-081431-A, the prediction accuracy improves as the number of actual values increases sufficiently. However, it takes time to accumulate a sufficient number of actual values for use in prediction, and for periods in which there are few actual values or for APIs that are executed infrequently, the number of actual values is insufficient, and therefore, the prediction accuracy is insufficient.

Moreover, even if a sufficient number of actual values have been accumulated, for events that follow device-specific behavior rather than statistical properties, the prediction accuracy is low in some cases.

Moreover, in services like clouds to which a large number of unspecified users connect via general networks, it is difficult to predict the lengths of processing time required for configuration operations, due to external factors. For example, depending on the number of devices connected to a network to which clients and systems on clouds connect and the amount of communication performed by applications running on each device via the network, the communication load changes, and the communication load affects the length of processing time.

A management system of a storage system calculates a prediction value of a required length of time by an analytical model, which is a model of an ideal operation performed in response to an operation request for an API, calculates a prediction value of the required length of time by a statistical model, which is a model constructed on the basis of statistics of history of an operation performed in response to the operation request for the API, and determines a prediction value of the required length of time from those prediction values and weights of those models.

According to the present invention, it is possible to improve the prediction accuracy of required lengths of time for management operations to be performed in the storage system in response to operation requests made via the communication network from the API for management operations.

### BRIEF DESCRIPTION OF THE DRAWINGS

FIG. 1 illustrates an example of an overall configuration of a computer system according to Embodiment 1;

FIG. 2 illustrates an example of a configuration of a storage system according to Embodiment 1;

FIG. 3 illustrates examples of configurations of a program and a management table group of a management node according to Embodiment 1;

FIG. 4 illustrates an example of processing of predicting a length of time required for an operation requested by an API according to Embodiment 1;

FIG. 5 illustrates an example of a model processing unit according to Embodiment 1;

FIG. 6 illustrates an example of a model definition table according to Embodiment 1;

FIG. 7 illustrates an example of a model coefficient table according to Embodiment 1;

FIG. 8 illustrates an example of a resource management table according to Embodiment 1;

FIG. 9A illustrates a part of an example of a required time history table according to Embodiment 1;

FIG. 9B illustrates the remaining part of the example of the required time history table according to Embodiment 1;

FIG. 10 illustrates an example of a required time prediction technique in a statistical model unit according to Embodiment 1;

FIG. 11 illustrates an example of a processing flow of the management node according to Embodiment 1;

FIG. 12 illustrates an example of a processing flow in factor determination processing according to Embodiment 1;

FIG. 13 is an example of a sequence diagram for detecting a sign of a problem according to Embodiment 2;

FIG. 14 illustrates an example of the configuration of the management table group according to Embodiment 2;

FIG. 15 illustrates an example of a problem sign threshold table according to Embodiment 2;

FIG. 16 illustrates an example of a part of the required time history table according to Embodiment 2;

FIG. 17 illustrates examples of the configurations of the program and the management table group of the management node according to Embodiment 3;

FIG. 18 illustrates an example of a MAX value table according to Embodiment 3;

FIG. 19 illustrates an example of a processing flow for adding an insufficient resource according to Embodiment 3; and

FIG. 20 illustrates an example of a part of the required time history table according to Embodiment 4.

### DESCRIPTION OF THE PREFERRED EMBODIMENTS

In the following description, “interface device” may refer to one or more interface devices. The one or more interface devices may be at least one of the following.
One or more I/O interface devices. The I/O interface device is an interface device for at least one of an I/O device and a remote display computer. The I/O interface device for the display computer may be a communication interface device. At least one I/O device may be any of user interface devices, for example, an input device such as a keyboard or a pointing device, and an output device such as a display device.
One or more communication interface devices. The one or more communication interface devices may be one or more communication interface devices of the same type (for example, one or more network interface cards (NICs)) or two or more communication interface devices of different types (for example, NIC and host bus adapter (HBA)).

Further, in the following description, “memory” may refer to one or more memory devices, typically, main storage devices. At least one memory device in the memory may be a volatile memory device or a non-volatile memory device.

Further, in the following description, “persistent storage device” refers to one or more persistent storage devices. The persistent storage device is typically a non-volatile storage device (for example, auxiliary storage device), specifically, for example, a hard disk drive (HDD) or a solid-state drive (SSD).

Further, in the following description, “storage device” may refer to at least a memory between a memory and a persistent storage device.

Further, in the following description, “processor” refers to one or more processor devices. At least one processor device is typically a microprocessor device such as a central processing unit (CPU), but may be other types of processor devices such as a graphics processing unit (GPU). At least one processor device may be a single-core or multi-core processor device. At least one processor device may be a processor core. At least one processor device may be a processor device in a broad sense such as a hardware circuit (for example, a field-programmable gate array (FPGA) or an application-specific integrated circuit (ASIC)) configured to perform part or all of the processing.

Further, in the following description, data (information) for obtaining an output for an input may be described with such expressions as “xxx table,” but the data (information) in question may be data of any structure, or a learning model represented by a neural network, a genetic algorithm, or a random forest configured to generate an output for an input. Therefore, “xxx table” can be called “xxx data.” Further, in the following description, one table may be divided into two or more tables, or all or part of two or more tables may be one table.

Further, in the following description, functions may be described with such expressions as “yyy unit,” but the functions may be implemented by one or more computer programs being executed by a processor, may be implemented by one or more hardware circuits (for example, FPGAS or ASICs), or may be implemented by a combination thereof. When a function is implemented by a program being executed by a processor, since defined processing is performed using storage devices, interface devices, and/or the like as appropriate, the function may be regarded as at least part of the processor. Processing described with a function as the subject may be processing that a processor or a device including that processor performs. The program may be installed from a program source. The program source may be, for example, a program distribution computer or a computer-readable recording medium (for example, a non-transitory recording medium). The descriptions of each function are examples, and a plurality of functions may be combined into one function, or one function may be divided into a plurality of functions.

Furthermore, in the following description, when elements of the same type are described without distinction, common symbols among reference symbols may be used, while the reference symbols may be used when elements of the same type are described with distinction.

### Embodiment 1

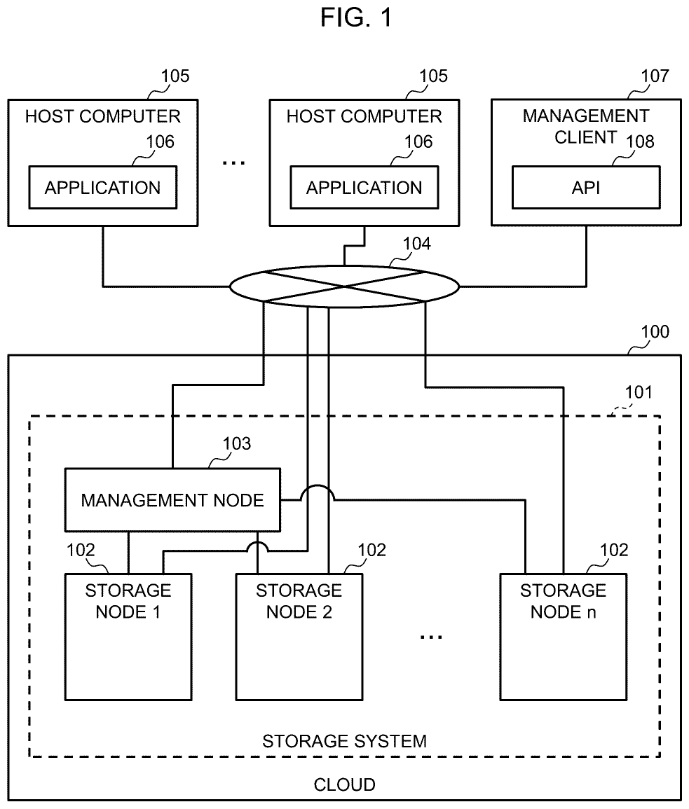

With use of FIG. 1 to FIG. 12, embodiments are described for a storage management system, namely, a technique for managing APIs to be executed on a storage system and predicting a required length of time for the completion of processing requested by an API on the storage system.

FIG. 1 is an overall configuration diagram of a computer system according to Embodiment 1.

The computer system includes a storage system 101, host computers 105, and a management client 107. The storage system 101 includes (one or) two or more storage nodes 102 and a management node 103 configured to manage the storage nodes 102. In the present embodiment, the storage system 101 is provided on a cloud 100. The cloud 100 may mean cloud computing and is a system that can utilize computer resources such as a CPU, a memory, and a storage via a network.

The host computers 105 each operate services that form the cores of business systems, for example, and from various applications 106 running on the host computer 105, processing of reading/writing user data (data to be read/written from/to volumes provided by the storage system 101) can be requested to the storage system 101. The host computers 105 may each be a physical computer or a virtual computer.

The management client 107 can utilize an API 108 provided by the management node 103. The management client 107 can acquire configuration information on the storage nodes 102 managed by the management node 103, and can create, change, or update configurations of the storage nodes 102, for example. The management client 107 may be a physical computer or a virtual computer. The unit of the API 108 may be any unit and may be, for example, per operation such as creating a volume or connecting a path to a volume. The utilization of the API 108 may be performed in response to instructions from a user of the management client 107 or may be performed automatically in a manner following a script.

The storage nodes 102, the management node 103, the host computers 105, and the management client 107 are connected via a communication network 104. The communication network 104 may be configured through a combination of, for example, a local area network (LAN) and a wide area network (WAN).

The storage system 101 in the present embodiment is, for example, a software-defined storage (SDS) and represents an example of a system on the cloud 100, but may be a system on-premises that a user owns and operates in-house.

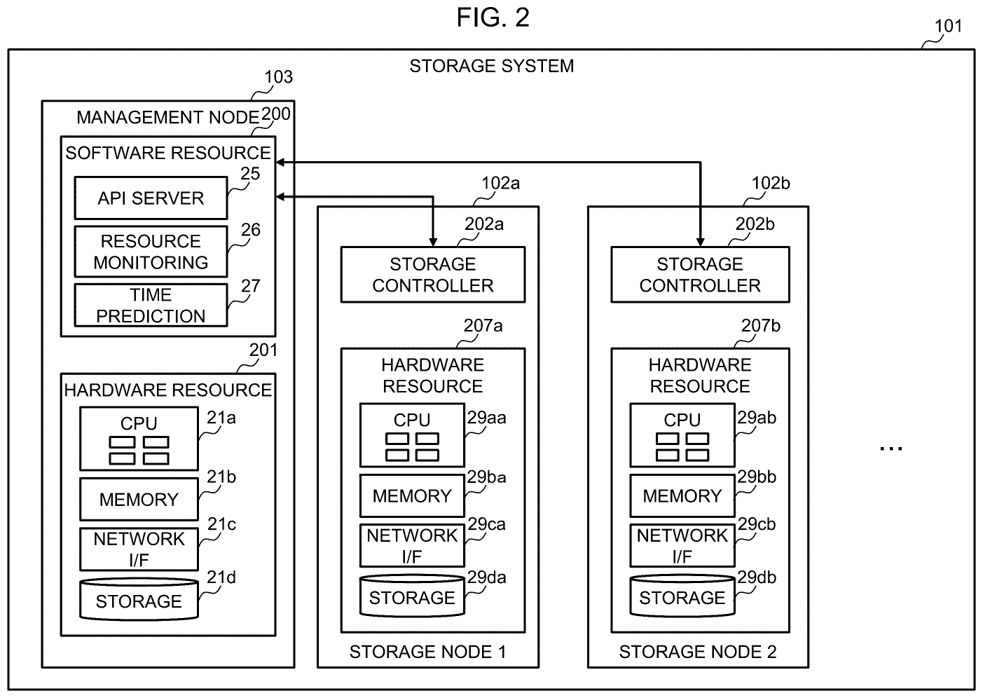

FIG. 2 is an example of a configuration of the storage system 101 according to Embodiment 1.

The storage system 101 includes the storage node 102 and the management node 103 and is configured for the purpose of providing non-volatile storage areas to the host computer 105. The storage node 102 includes a storage controller 202 and a hardware resource 207 (including, for example, computer resources such as a CPU 29a, a memory 29b, a network interface (I/F) 29c, and a storage 29d). The management node 103 includes a hardware resource 201 (including, for example, computer resources such as a CPU 21a, a memory 21b, a network I/F 21c, and a storage 21d) and a software resource 200 including, for example, programs for performing user data operations and storage configuration management processing by utilizing the hardware resource 201. The hardware resource 207 or 201 in the present embodiment is mainly a virtual computer on the cloud 100, but the hardware resource 207 or 201 may be a physical computer in cases such as when the storage system 101 is a system on-premises.

In the management node 103, the software resource 200 performs API server processing 25 of receiving processing requests via the API 108 from the management client 107, resource monitoring processing 26 of monitoring the status of the hardware resource 207 of the storage node 102 through the storage controller 202, time prediction processing 27 of predicting a required length of time to complete the processing in the storage system 101 from the time when the API 108 makes a request, and the like. The software resource 200 may include programs, and the processing processes 25 to 27 described above may be performed by the programs being executed by the CPU 21a of the hardware resource 201.

Main software resources of the storage node 102 may be programs for controlling the storage node 102. The storage controller 202 may be implemented by the programs being executed by the CPU 29a of the hardware resource 207. The storage controller 202 may configure disk drives as redundant array of inexpensive disks (RAID) to provide logical disk areas called volumes to the host computer 105, or may provide storage-related functions (for example, functions such as volume creation, copying, or replication) to control the configuration of the storage node 102 and user data.

The resources such as the CPU 21a, the memory 21b, the network I/F 21c, and the storage 21d of the management node 103 are resources of virtual computers allocated mainly for processing for managing the system 101, such as changing the configuration of the storage system 101. The cloud 100 has a mechanism in which a plurality of types of virtual computers are provided with specified performance for each resource, such as the CPU operating frequency, the number of cores, the memory bandwidth and size, the storage type such as an HDD or an SSD, the storage size, and the network bandwidth, and the performance of the virtual computers can be changed through a selection of these types. With use of this mechanism, it is possible to scale up the resources of the virtual computers. Further, the cloud 100 has a mechanism that can improve the management performance by adding the resources of one virtual computer of the management node 103 and introducing a mechanism configured to distribute processing across a plurality of machines, to thereby scale out the virtual computers of the management node 103 and enhance the resources.

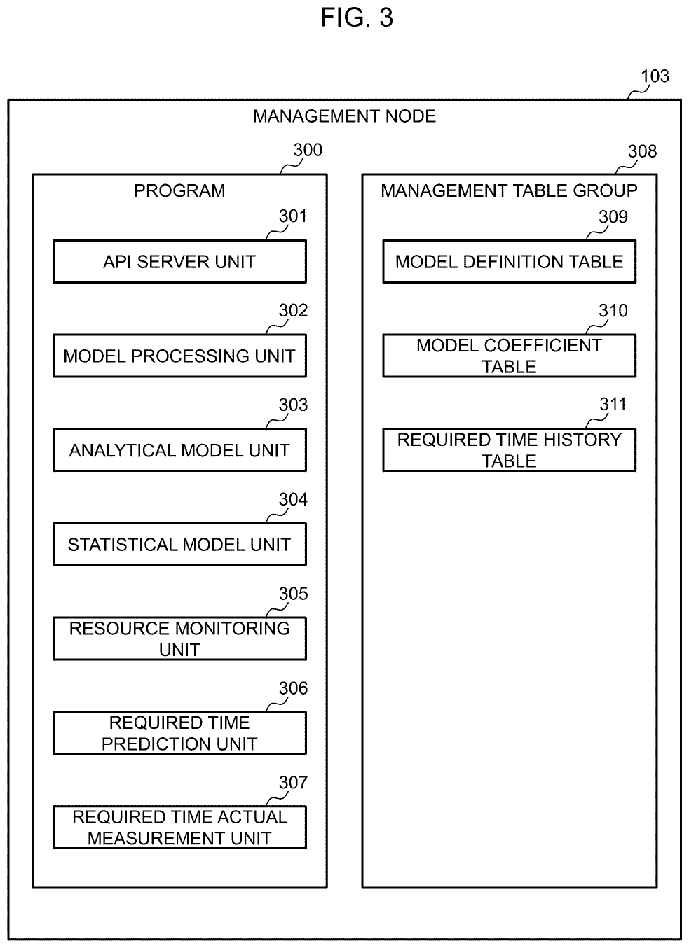

FIG. 3 illustrates configurations of a program 300 and a management table group 308 of the management node 103 according to Embodiment 1.

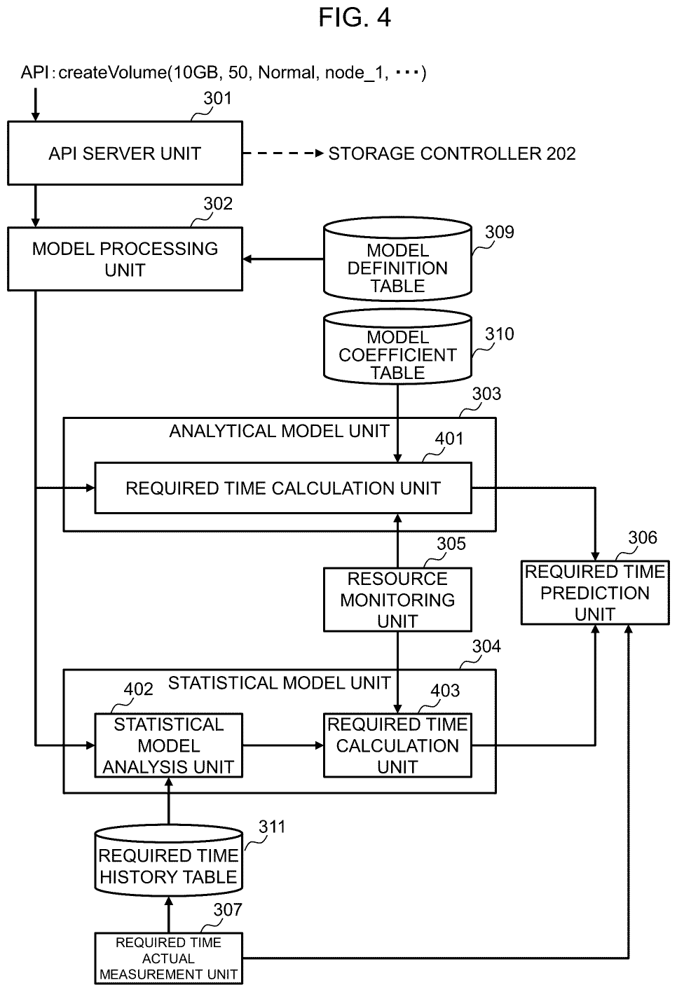

In the management node 103, when the program 300 is executed by the CPU 21a, such functions as an API server unit 301, a model processing unit 302, an analytical model unit 303, a statistical model unit 304, a resource monitoring unit 305, a required time prediction unit 306, and a required time actual measurement unit 307 are implemented. The management table group 308 includes a model definition table 309, a model coefficient table 310, and a required time history table 311. Examples of the processing of each component that is performed by the program 300 being executed are described later with FIG. 4. The management table group 308 may be, for example, a database and may be operated by utilizing Structured Query Language (SQL) from the program 300.

FIG. 4 illustrates processing of predicting a length of time required for an operation requested by an API according to Embodiment 1.

First, the management node 103 receives a processing request by the API 108 with specified parameters from the management client 107.

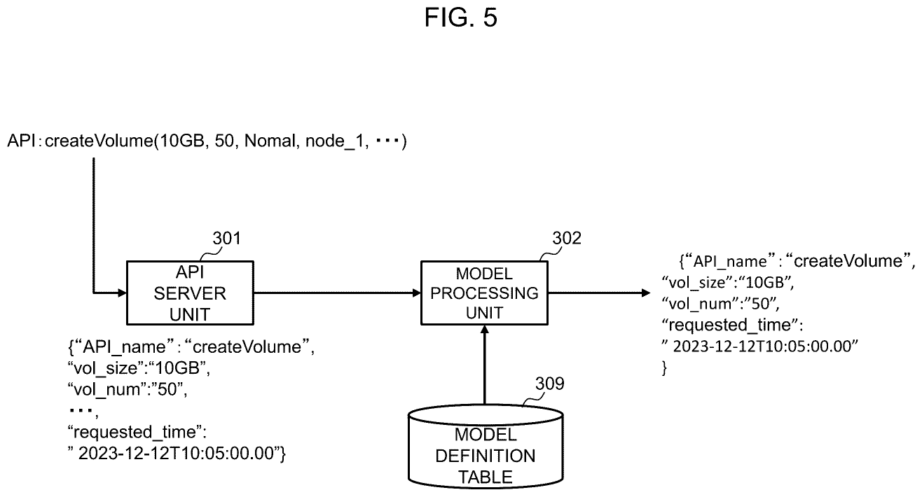

The management node 103 gives instructions for processing to the storage controller 202 in accordance with the API parameters received in the API server unit 301. Meanwhile, the model processing unit 302 acquires, from the plurality of parameters specified by the API, necessary parameters to be passed to the analytical model unit 303 and the statistical model unit 304, which are described later, in accordance with the model definition table 309 of the management table group 308. The parameters extracted by the model processing unit 302 are passed to the analytical model unit 303 and the statistical model unit 304. An example of processing of the model processing unit 302 is illustrated in FIG. 5.

The analytical model unit 303 includes a required time calculation unit 401. The required time calculation unit 401 calculates a length of time required for processing related to each operation provided by the API 108, in a manner following a given calculation method. “Analytical model” referred to here may be a model configured to take, as input, quantities (for example, explanatory variables) that determine a required length of time (for example, objective variable), which is output, as well as quantitative relations thereof, and may be, for example, a mathematical model or a machine learning model such as a neural network model. For example, as with general industrial products, the relation between configuration items of the configuration operation (for example, change operation) and the expected required length of time can be recognized from prior verification and operational performance by the designers or manufacturers of the storage system, and the analytical model is constructed as a model configured to represent such a relation. However, due to individual differences, usage conditions, and the like, the predicted length of time does not exactly match the expected value, and hence, it is attempted to absorb the error between the predicted length of time and the expected value through adjustment of model coefficients for the analytical model. The required time calculation unit 401 inputs quantities related to a required length of time to the above-mentioned analytical model, thereby calculating (acquiring) a predicted required length of time.

An example of a relation between the required length of time and known quantities implemented in the analytical model is described next. For example, a required length of time Ta for an API for volume creation in the storage system 101 increases as the number of volumes to be created increases and as the volume size increases. Therefore, the required length of time Ta is proportional to such parameters as the number of volumes and the volume size. Further, the required length of time Ta increases as loads such as the CPU utilization rate, the memory usage, and the network usage rate of the storage node 102 are higher and tighter, and hence, the required length of time Ta is proportional to parameters related to these loads of the storage node. Moreover, since the processing of the API 108 is analyzed in the management node 103 and instructions for processing are given to the storage controller 202 of each of the storage nodes 102, processing takes time in situations where the utilization rate of the management node 103 is high, resulting in the required length of time Ta being longer. The predicted length of time of the required length of time Ta by the analytical model can be expressed by the following equation.

$$Ta = α \times number of volumes \times volume size \text{} + β0 \times CPU utilization rate of storage node \text{} + β1 \times memory usage rate of storage node + β2 \times network usage rate of storage node \text{} + γ \backslash [ NoBreak ] 0 \times CPU utilization rate of management node \text{} + γ 1 \times memory usage rate of management node \text{} + γ \text{} 2 \times network usage rate of management node \qquad ( Equation 1 )$$

The required time calculation unit 401 of the analytical model unit 303 calculates (predicts) the required length of time Ta on the basis of the parameters extracted by the model processing unit 302, the model coefficient table 310, and the parameters corresponding to the statuses (utilization rates/usage rates) of each resource acquired by the resource monitoring unit 305.

The initial values of the respective model coefficients α, β0 to β2, and γ indicated in the model coefficient table 310 may be values calculated on the basis of the results of performance evaluation in an environment assumed at the design stage of the storage system 101.

As described above, when a wide-area network environment such as the cloud 100 is utilized, the load of the network changes depending on the number of devices communicating on the network and the amount of communication utilized by applications running on each device. The network load differs depending on the system environment actually utilized, and hence, accurate prediction before operation is difficult.

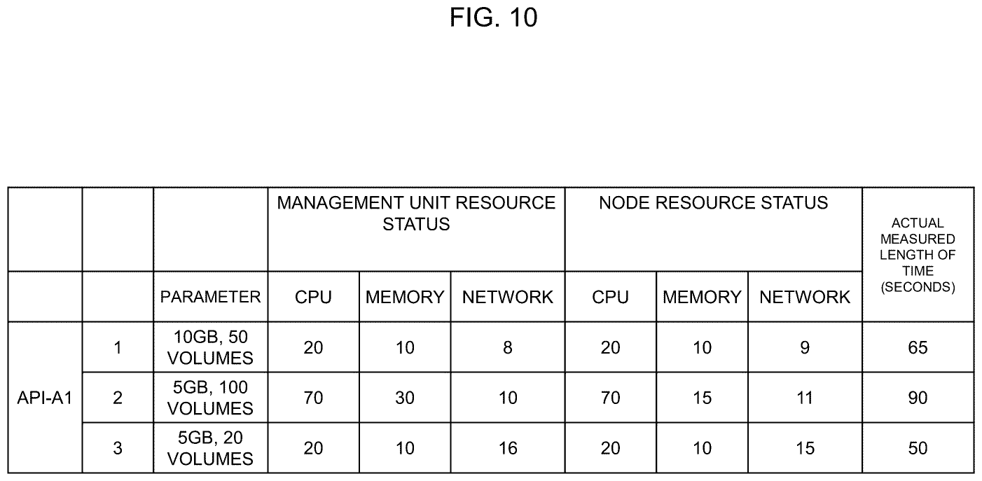

Therefore, the prediction of the required length of time in the statistical model unit 304 is used in combination. The statistical model unit 304 includes a statistical model analysis unit 402 and a required time calculation unit 403. The statistical model analysis unit 402 extracts history information on a target API from the required time history table 311, obtains a correlation between the utilization rate of each resource and the required length of time by use of a statistical technique, and uses this correlation as a statistical model. As the statistical technique, various well-known techniques such as principal component analysis and cluster analysis can be applied. The accuracy of statistical analysis differs depending on the amount of accumulated history information (typically, the number of accumulated actual values), and hence, the timing of model creation and updating may be adjustable. More specifically, for example, the statistical model unit 304 may update the statistical model each time the API 108 is executed and a record is recorded. Alternatively, the statistical model unit 304 may accumulate records for a certain period such as every other day, may measure the number of accumulated records, and may update the statistical model when the number of accumulated records exceeds a set threshold. Various other model update timings are conceivable, and this example does not limit the model update timing. The required time calculation unit 403 acquires the current status of each resource from the resource monitoring unit 305, and calculates (predicts) a required length of time with the current statuses of the resources by utilizing the statistical model (that is, the correlation between the utilization rate of each resource and the required length of time) obtained by the statistical model analysis unit 402. An example of predicting a required length of time by the statistical model is described later with reference to FIG. 11.

The required time prediction unit 306 determines a predicted length of time (a prediction value of the required length of time) by utilizing a predicted length of time by the analytical model and a predicted length of time by the statistical model. More specifically, for example, the average value of a predicted length of time by the analytical model and a predicted length of time by the statistical model is used as a predicted length of time. In this case, a predicted length of time that takes into account both the analytical model and the statistical model is determined. Further, as another technique, there is a method that weights each predicted length of time from the analytical model and the statistical model to determine a predicted length of time. As a characteristic of the statistical model, in situations where records are not sufficiently accumulated (for example, the number of records is equal to or less than a certain number), the variation in numerical values is large and the accuracy is low in some cases, and during that period, more weight is given to the predicted length of time by the analytical model to increase the proportion of adopting the predicted length of time by the analytical model, so that the accuracy can be improved. As a more specific value for weighting, the variance value of past predicted lengths of time of the statistical model may be calculated, and the weight of the predicted length of time of the analytical model may be increased as the variance value is larger, and the weight of the predicted length of time of the statistical model may be increased as the variance value is smaller.

Moreover, the required time prediction unit 306 compares the calculated required length of time (predicted length of time) with a required length of time that has actually been taken (actual measured length of time), and corrects at least one of the analytical model and the statistical model (for example, the analytical model) by use of a technique described later. With this, the accuracy of subsequent predictions of the required length of time is expected to improve.

FIG. 5 illustrates an example of the processing of the model processing unit 302 according to Embodiment 1.

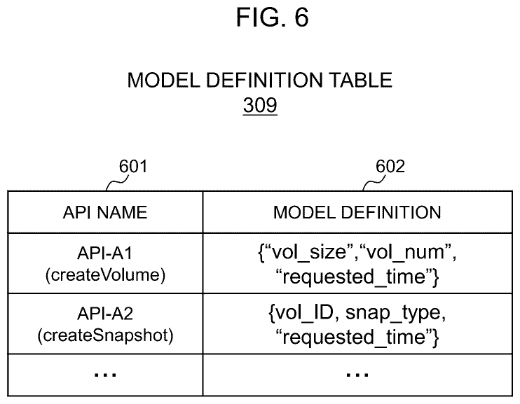

The model processing unit 302 acquires, for processing requested by each of the APIs 108, parameters that affect the processing length of time in the storage system 101. The API server unit 301 analyzes the parameters that are specified by the API 108 and are received from the management client 107. The model processing unit 302 utilizes the model definition table 309 to acquire necessary parameters. An example of the model definition table 309 is as illustrated in FIG. 6. That is, the model definition table 309 has entries for each of the APIs 108, and the entries have such information as an API name 601 and a model definition 602. The API name 601 is the name of the API. The model definition 602 is a list of parameters, among parameters specified by the API 108, that are utilized in the analytical model and/or the statistical model.

For example, an example of a case where a createVolume API configured to create volumes is executed from the management client 107 is as follows. The API server unit 301 analyzes the API name and parameters specified by the API, and acquires information in the JSON format such as {“API_name”: “createVolume,” “vol_size”: “10 GB,” “vol_num”: “50,” . . . , and “requested_time”: “2023-12-12T10:05:00.00”}. In volume creation, the volume size and the number of volumes affect the processing length of time (required length of time) in the storage system 101, and hence, {“vol_size,” “vol_num,” and “requested_time”} are specified in the model definition table 309 as parameters (parameter items) to be acquired for the createVolume API. These parameters are parameters that affect the required length of time in the analytical model, and also in the statistical model, “requested_time” is a parameter necessary for identifying the processing requested by the API. As the parameters (parameter values) to be acquired, {“API_name”: “createVolume,” “vol_size”: “10 GB,” “vol_num”: “50,” and “requested_time”: “2023-12-12T10:05:00.00”} are acquired. The values of each parameter acquired here are used in the analytical model and/or the statistical model.

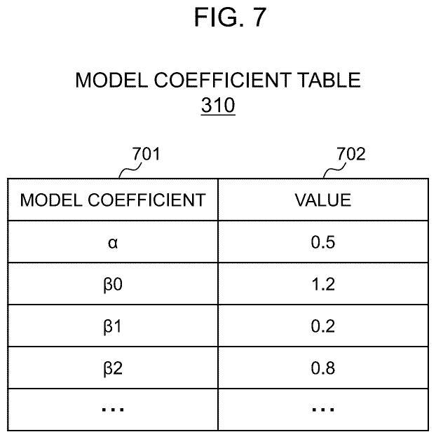

FIG. 7 illustrates an example of the model coefficient table 310 according to Embodiment 1.

The model coefficient table 310 indicates model coefficients 701 and their values 702 that are used for reducing an error in a required length of time predicted using the analytical model assumed for the storage system 101.

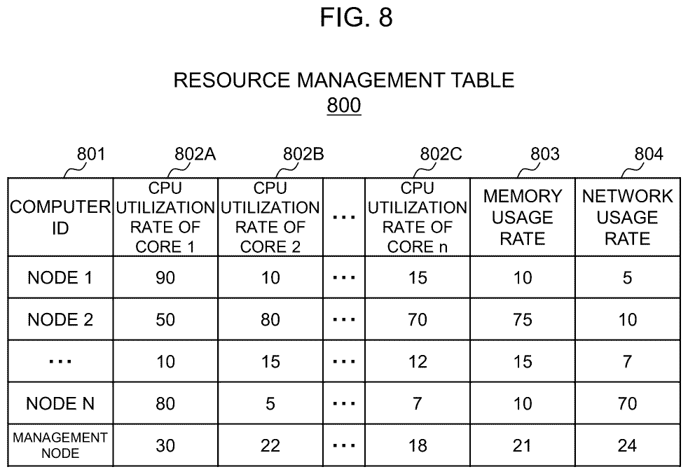

FIG. 8 illustrates an example of a resource management table 800 according to Embodiment 1.

The resource management table 800 has entries for each virtual computer (the storage node 102 or the management node 103) of the storage system 101. The entries have such information as a computer ID 801 and utilization rates/usage rates 802 to 804.

The computer ID 801 represents the ID of the storage node 102 or the management node 103. As the utilization rates/usage rates 802 to 804, there are the CPU utilization rate 802, the memory usage rate 803, and the network usage rate 804. The CPU utilization rate 802 is provided for each core of the CPU 21a or 29a and represents the core utilization rate. The memory usage rate 803 represents the usage rate of the memory 21b or 29b. The network usage rate 804 represents the usage rate of the network I/F 21c or 29c.

The resource monitoring unit 305 acquires information on the operational statuses (the CPU utilization rates, the memory usage rates, and the network usage rates) of the resources of each virtual computer of the storage system 101. For each virtual computer, the statuses of each resource such as a CPU and a memory secured in the virtual computer are monitored, records for a certain period are retained, and the utilization rates/usage rates of each resource are measured. The resource monitoring unit 305 is called when the analytical model unit 303 or the statistical model unit 304 calculates a predicted length of time, acquires utilization rates/usage rates calculated within each virtual computer at that point, and returns those values. In this example, the CPU utilization rate, the memory usage rate, and the network usage rate are adopted, but in place of or in addition to at least one of those, information on measurement values of latency or throughput of the storage system 101 allocated to each virtual computer may be acquired. For example, in the analytical model, if the latency is high and the throughput is low, the processing length of time increases, and hence, a term that expresses this is added to (Equation 1) described above, and a model that takes into consideration the impact of the performance of the storage system 101 is created. Similarly, measurement information on the latency and throughput of the storage system 101 is stored as records in the required time history table 311 to construct a statistical model with the latency and throughput information included in the prediction of the required length of time, and a model that takes into consideration the impact of the performance of the storage system 101 is created. The model is a statistical model with items of the latency and throughput of the storage system 101 added to (Equation 2) described later. With this, the accuracy of prediction values in the analytical model and the statistical model can be improved in consideration of the impact of the performance of the storage system 101 allocated to each virtual computer on each API.

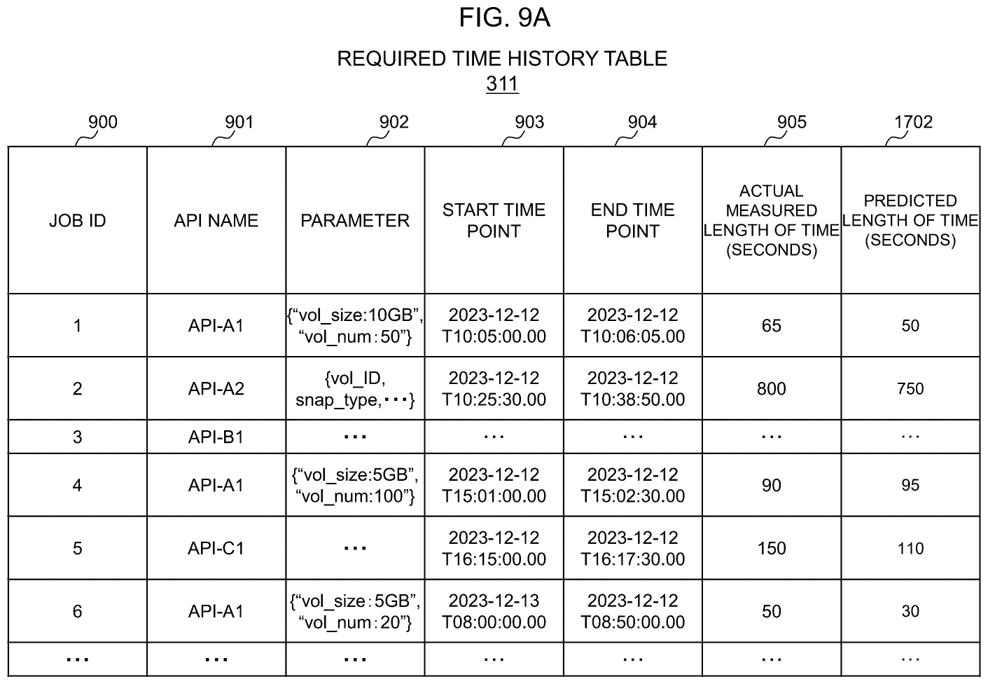

FIG. 9A and FIG. 9B illustrate an example of the required time history table 311 according to Embodiment 1.

The required time history table 311 has entries for each of the APIs 108. The entries have such information as a job ID 900, an API name 901, a parameter 902, a start time point 903, an end time point 904, an actual measured length of time 905, a predicted length of time 1702, a management unit resource status 906, and a node resource status 907.

The job ID 900 represents the ID of the job. The API name 901 represents the name of the API 108. The parameter 902 represents a list of parameters (pairs of parameter items and parameter values) specified by the API 108. The start time point 903 represents the start time point of the operation in accordance with the request received by the API 108. The end time point 904 represents the end time point of the operation in accordance with the request received by the API 108. The actual measured length of time 905 represents the required length of time (actual value) of the operation in accordance with the request received by the API 108, specifically, the length of time from the time point indicated by the start time point 903 to the time point indicated by the end time point 904. The predicted length of time 1702 represents the predicted length of time determined by the required time prediction unit 306. The management unit resource status 906 represents the utilization rates/usage rates (the CPU utilization rate, the memory usage rate, and the network usage rate) of the resources of the management node 103. The node resource status 907 represents the utilization rates/usage rates (the CPU utilization rate, the memory usage rate, and the network usage rate) of the resources of the storage node 102. For each of the resource statuses 906 and 907, the stored utilization rate/usage rate value is a statistical value (for example, an average value) of the utilization rates/usage rates during the period from the time point indicated by the start time point 903 to the time point indicated by the end time point 904. A required length of time is predicted by the statistical model by utilizing this required time history table 311.

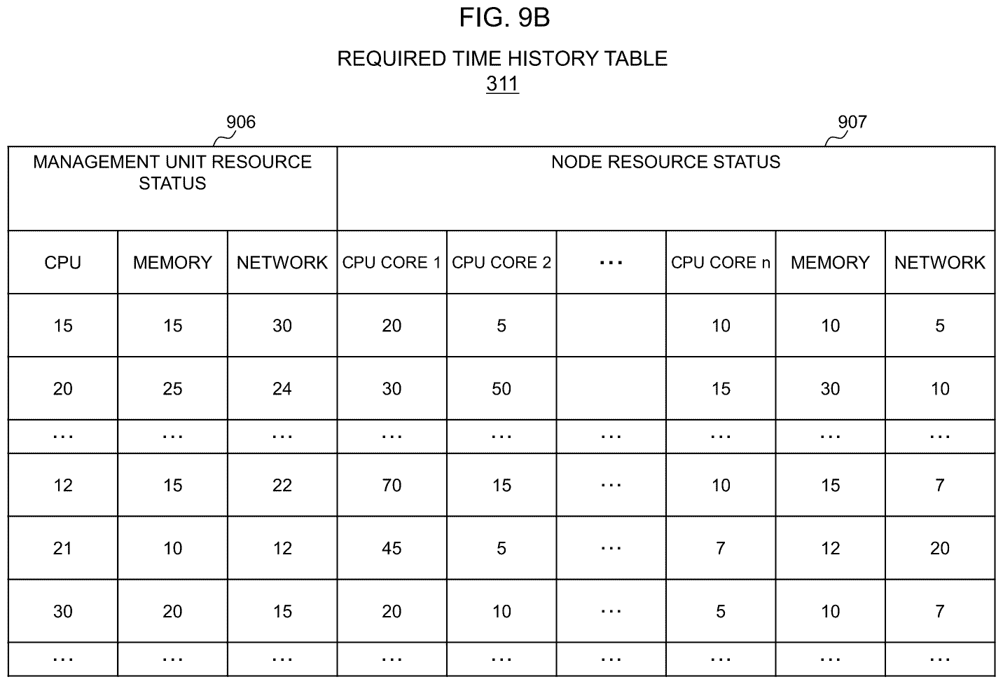

FIG. 10 illustrates an example of a required time prediction technique in the statistical model unit 304 according to Embodiment 1.

First, the statistical model analysis unit 402 acquires history information on the target API 108 from the required time history table 311. An example of the acquisition result of the history information is the table of FIG. 10. That is, for an API name (for example, “API-A1”), there are three records (entries), and the information held by each record is information representing a combination of a parameter, a management unit resource status (the CPU utilization rate, memory usage rate, and network usage rate of the management node 103), a node resource status (the CPU utilization rate, memory usage rate, and network usage rate of the storage node 102), and an actual measured length of time of the required length of time.

The statistical model analysis unit 402 analyzes the correlation between the utilization rate of each resource and the required length of time by use of a statistical technique on the basis of the acquisition result (table) illustrated in FIG. 10. Various techniques can be applied as the statistical technique, but here, an example in which multiple regression analysis is utilized is described. The statistical model analysis unit 402 sets the required length of time as an objective variable, and the parameters specified by the API, the resource status (the CPU utilization rate, the memory usage rate, and the network usage rate) of the management node 103, and the resource status (the CPU utilization rate, the memory usage rate, and the network usage rate) of the storage node 102 as explanatory variables. For example, for a certain target API 108, (Equation 2) described below is constructed as the equation for a required length of time for an operation in accordance with a request for that API 108.

$$Required length of time = A 0 + A 1 \times number of volumes + A 2 \times volume size \text{} + A 3 \times CPU utilization rate of storage node 102 \text{} + A 4 \times memory usage rate of storage node 102 \text{} + A 5 \times network usage rate of storage node 102 \text{} + A 6 \times CPU utilization rate of management node 103 \text{} + A 7 \times memory usage rate of management node 103 \text{} + A 8 \times network usage rate of management node 103 \qquad ( Equation 2 )$$

By utilizing the information in the required time history table 311, the statistical model analysis unit 402 obtains partial regression coefficients A0 to A8 of the multiple regression analysis by the least squares method. Using Equation 2, the statistical model analysis unit 402 predicts a required length of time for the target API 108 on the basis of the specified parameters and the acquired resource statuses (utilization rates/usage rates). It is also possible to predict the required length of time by other statistical techniques, and the statistical technique is not necessarily limited to any kind.

For each of the APIs 108, the accuracy (prediction accuracy) of the statistical analysis of the required length of time differs depending on the number of entries accumulated in the required time history table 311. Therefore, the timing of creating or updating the statistical model may be adjustable. For example, the statistical model analysis unit 402 may update the statistical model at the timing at which the API 108 is executed and a record (entry) is recorded once in the required time history table 311. Alternatively, the statistical model analysis unit 402 may accumulate records for a certain period such as every other day, may measure the number of accumulated records, and may update the statistical model when the number of accumulated records exceeds a set threshold. The trigger for history updating is not limited in the present embodiment. The required time calculation unit 403 acquires the current statuses of each resource from the resource monitoring unit 305, and calculates a required length of time with the current statuses of the resources by utilizing the correlation between the statuses (utilization rates/usage rates) of each resource of the statistical model and the required length of time, the correlation being obtained by the statistical model analysis unit 402.

FIG. 11 illustrates an example of a processing flow of the management node 103 according to Embodiment 1.

The model processing unit 302 acquires specified parameters corresponding to the model definition 602 corresponding to the requested API 108, as parameters necessary for the utilization of the analytical model and the statistical model (S1101).

The resource monitoring unit 305 acquires the resource statuses (utilization rates/usage rates) of the management node 103 and the storage node 102 (S1102).

The analytical model unit 303 acquires model coefficients from the model coefficient table 310 and calculates a predicted length of time by inputting the acquired model coefficients, the parameters acquired in S1101, and the numerical values (resource statuses) acquired in S1102 to the analytical model (S1103).

The statistical model unit 304 calculates a predicted length of time by inputting the parameters acquired in S1101 and the numerical values (resource statuses) acquired in S1102 to the statistical model (S1104).

The required time prediction unit 306 determines a predicted length of time of the processing (operation) requested by the target API, by utilizing the predicted length of time by the analytical model calculated in S1103 and the predicted length of time by the statistical model calculated in S1104 (S1105).

After the predicted length of time is determined in S1105, the API server unit 301 returns the predicted length of time determined in S1105, in response to an inquiry about the required length of time from the management client 107. Further, the required time actual measurement unit 307 actually monitors the completion of the processing in the storage node 102 by polling, checks whether the processing is completed or not, and records, if the processing is completed, the actual measured length of time of the processing and the like in the required time history table 311 (S1106). After that, the required time prediction unit 306 compares the predicted length of time determined in S1105 with the actual measured length of time (the actual value of the required length of time) to determine whether the actual measured length of time is longer than the predicted length of time by a certain threshold or more (S1107). If the determination result in S1107 is false (S1106: No), the processing flow ends. If the determination result in S1107 is true (S1107: Yes), to enhance the prediction accuracy of the required length of time, the management node 103 performs factor determination processing (S1108), and then the processing ends.

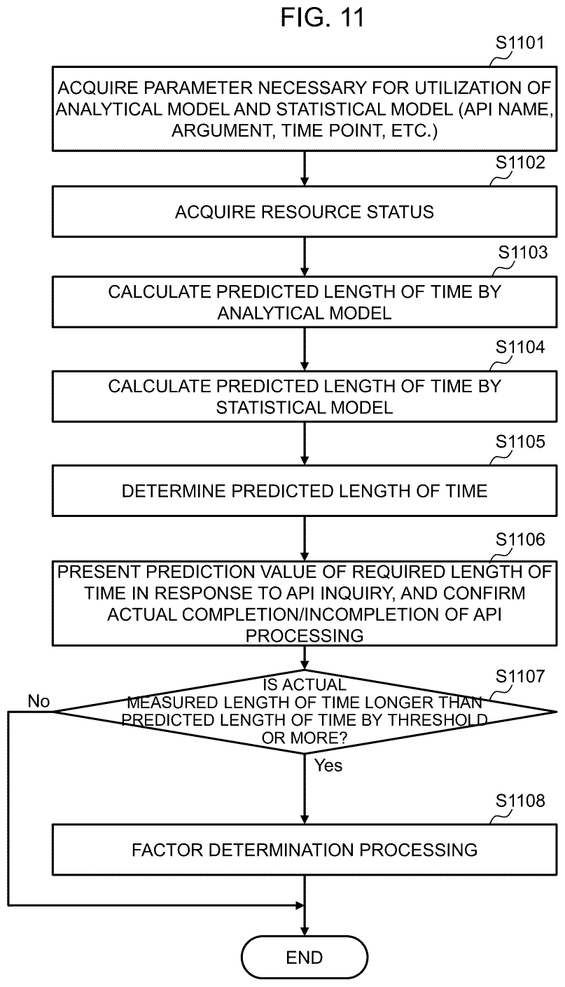

FIG. 12 illustrates an example of a processing flow in the factor determination processing (S1108) according to Embodiment 1.

For example, if it is detected that any of the following timings has come (S1201), the processing proceeds. If that timing is not detected, waiting is performed for a certain length of time until that timing is detected, and if that timing is not detected within a certain length of time, this factor determination processing may end.
The timing at which the resource monitoring unit 305 refers to the resource management table 800 (collection result) and determines that the overall resource utilization rate/usage rate is low (for example, the utilization rate/usage rate of each resource is equal to or less than a threshold).
The timing at which the resource monitoring unit 305 refers to the required time history table 311, identifies a period of time with less API execution (for example, a period of time in which the frequency of API execution per unit period of time is equal to or less than a predetermined value), and determines that the current period of time overlaps the identified period of time.

If the above-mentioned timing is detected, for an API corresponding to S1106: Yes (an API for which the predicted length of time of the required length of time by the analytical model deviates significantly from a threshold), the model processing unit 302 changes the parameters acquired in S1101 for the API in question to some extent, the analytical model unit 303 predicts a required length of time by the analytical model using the parameters obtained after the change, and the required time actual measurement unit 307 actually measures the required length of time for an operation with the parameters obtained after the change (S1202). Note that, in the example illustrated in FIG. 12, the volume size is changed to N, and the number of volumes is changed to M, but both N and M may be a value defined as not significantly affecting other operations of the virtual computer (for example, the storage node) in which the API in question is executed. The change of parameters may typically be a change of parameter values between parameter items and parameter values. Whether to increase or decrease the parameter value as a change of parameters may depend on the parameter item and the magnitude of the prediction error (the error in the predicted length of time of the required length of time), and the extent to which the parameter value is changed may depend on the magnitude of the prediction error.

The required time prediction unit 306 compares the actual measured length of time obtained in S1202 with the predicted length of time by the analytical model, and determines whether or not the result of the comparison (the relation between the actual measured length of time and the predicted length of time) has a tendency to follow the analytical model (S1203). An example of the “result of the comparison (the relation between the actual measured length of time and the predicted length of time) has a tendency to follow the analytical model” may be that the prediction error (the difference between the actual measured length of time and the predicted length of time) is within a certain range.

For example, in an API configured to create volumes, if the difference between the predicted length of time of the analytical model and the actual measured length of time when 10 volumes with a volume size of 10 GB are created is greater than a threshold, the current performance of the storage system 101 has possibly been changed from the current assumption of the analytical model. Therefore, measurements are performed with 20 volumes with a volume size of 10 GB, or with 10 volumes with a volume size of 20 GB (S1202). The predicted length of time by the analytical model at this time is compared with the corresponding actual measured length of time to determine whether the difference therebetween is equal to or smaller than a certain threshold (S1203).

If the determination result in S1203 is true (S1203: Yes), since the method of the analytical model is still usable, the required time prediction unit 306 corrects the values (values 702) of the model coefficients used in the analytical model in question, in such a manner that the predicted length of time of the analytical model matches the actual measured length of time (S1204).

If the determination result in S1203 is false (S1203: No), the required time prediction unit 306 estimates that the factor of the prediction error is other than the analytical model, and increases the weight of the statistical model in the required time prediction unit 306 (S1205). With this, the accuracy of a predicted length of time determined by the required time prediction unit 306 can be improved.

### Embodiment 2

Embodiment 2 is described. In this description, points different from Embodiment 1 are mainly described, while descriptions of points common to Embodiment 1 are omitted or simplified.

Among items of processing (operations) to be executed on the storage system 101 with the API 108, there is some time-consuming and high-load processing such as processing involving many resource configuration changes and volume deletion. Moreover, the processing length of time changes in some cases depending on the congestion level of the communication network 104 or the server (here, the management node 103) through which the API 108 passes. These problems are attributable to the insufficient performance or internal failures of the management node 103. In Embodiment 2, signs of the above-mentioned problems are detected based on a determination that the difference between a prediction value of a required length of time that is calculated by the technique in Embodiment 1 for processing executed by an API and an actual measurement value of an actual required length of time has become equal to or greater than a defined threshold.

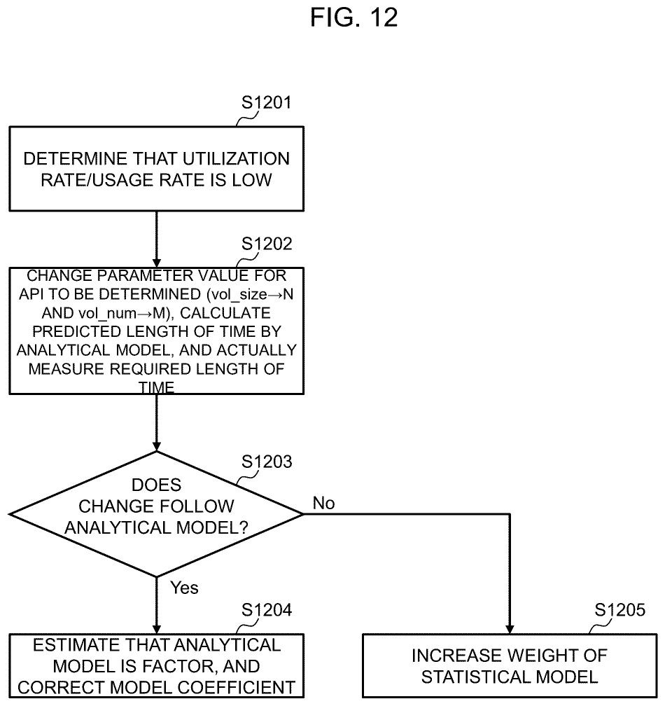

FIG. 13 illustrates an example of a flow of sequence processing of detecting a sign of a problem according to Embodiment 2.

An API is requested from the management client 107 to the storage system 101 (S1301). In the storage system 101, the required time prediction unit 306 of the management node 103 determines a predicted length of time T of the requested API (S1302). The determined predicted length of time T is stored in the required time history table 311 together with the job ID of the processing of the API. Simultaneously, the management node 103 performs processing on the storage node 102 specified in response to the request. The management node 103 monitors by polling the length of time of the processing actually being performed by the storage node 102, or receives a completion notification from the storage node 102, thereby acquiring an actual measured length of time A of the processing performed by the storage node 102 (S1303).

When the management client 107 wants to acquire a required length of time for the processing executed by the API requested in S1301, the management client 107 acquires the job ID managed by the management node 103, as a return value of the API requested in S1301. With this, the management client 107 can identify the job ID of the processing executed by the API, with use of the job ID managed by the management node 103. The management client 107 specifies this job ID and executes a predicted time acquisition API configured to request predicted lengths of time of required lengths of time, thereby acquiring the predicted length of time T of the processing executed by the API corresponding to the job ID from the management node 103 (S1304). By acquiring the predicted length of time T, the management client 107 can predict a required length of time, which makes it easier to plan other tasks.

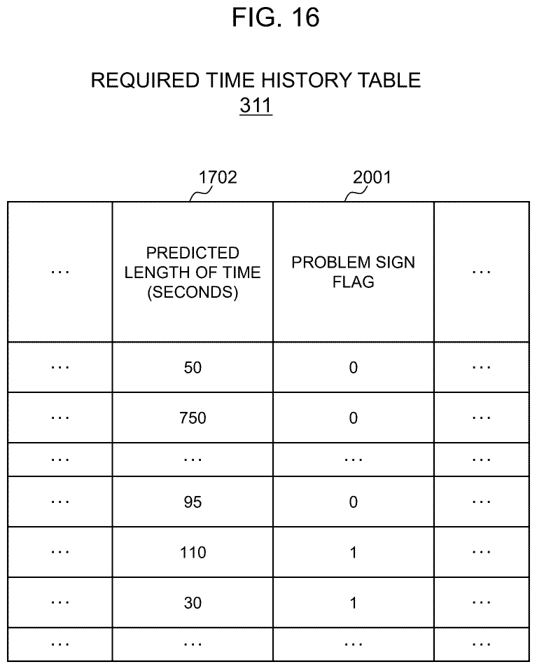

Next, the method of detecting signs of problems in the management node 103 is described. The management node 103 has a problem sign flag 2001 (see FIG. 16) in the required time history table 311, and sets this problem sign flag to “1” if there is a possibility that a problem has occurred regarding API execution for each job ID, and to “0” if there is no problem. Further, the management node 103 acquires a threshold P for problem sign detection from a problem sign threshold table 1401 (S1305), and compares the acquired actual measured length of time A with the sum of the predicted length of time T and the threshold P for problem sign detection. If the actual measured length of time A exceeds the sum of the predicted length of time T and the threshold P (A>T+P), it is determined that a problem has occurred, and the management node 103 sets the problem sign flag 2001 of the target job ID to “1” (S1306). If the actual measured length of time A does not exceed the sum of the predicted length of time T and the threshold P (A≤T+P), the management node 103 sets the problem sign flag 2001 of the target job ID to “0.”

The management client 107 executes a problem diagnosis API configured to check if a problem has occurred, and can recognize whether a problem has occurred by checking the problem sign flag of the target job ID recorded in the required time history table 311 (S1307). With this, the possibility of a problem occurring can be detected early, making it possible to take countermeasures early.

Further, as another technique for the management client 107 to recognize the result of the problem sign flag, a method that includes the predicted length of time determined by the required time prediction unit 306 in the return value of the API requested in S1301 on the management client 107 side and sends back the resultant is conceivable. In this case, for asynchronous APIs, the predicted length of time is included in the return value and the resultant is sent back at the timing after predicted time calculation in the required time prediction unit 306. In contrast, for synchronous APIS, since the return value is not sent back until the processing is completed, the predicted length of time cannot be utilized as a prediction, but if the problem sign flag 2001 is set, it can be checked whether to consider countermeasures for an improvement in subsequent API executions or not.

Furthermore, as still another method, a technique that notifies the management client 107 side of the predicted length of time determined by the required time prediction unit 306 is also conceivable. For example, the management client 107 side has a mechanism capable of receiving push notification messages. The management node 103 creates a push notification type message with the calculated prediction value and the job ID of the API, and delivers the created push notification message to the management client 107 side. With this, the management client 107 can find the prediction value of the required length of time for the processing executed by the requested API. In this manner, various predicted time notification methods are conceivable, and the present application does not limit the predicted time notification method.

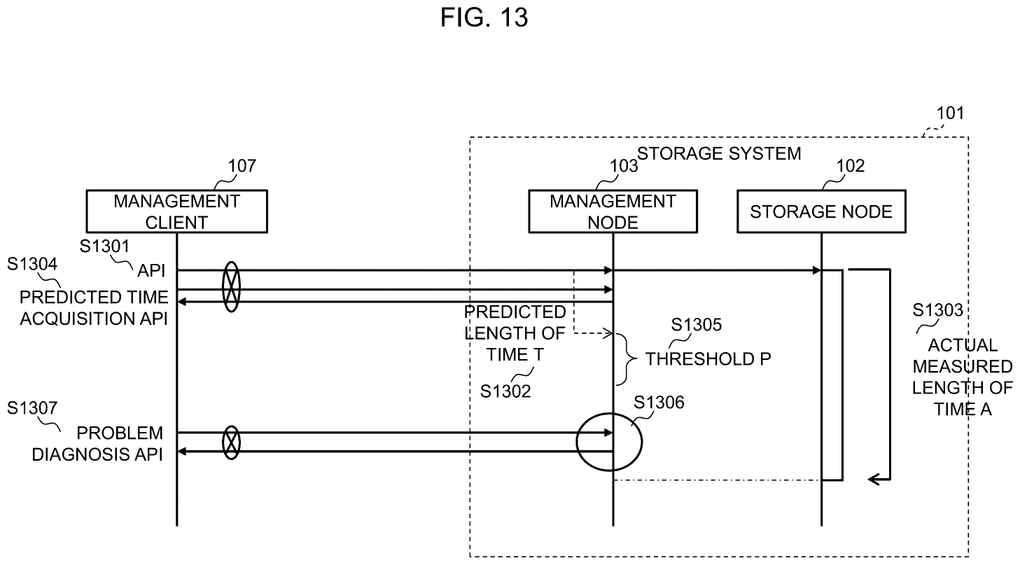

FIG. 14 illustrates an example of the configuration of the management table group 308 according to Embodiment 2.

The management table group 308 of FIG. 3 includes, in addition to the tables 309 to 311, the problem sign threshold table 1401 in which thresholds for the difference between the predicted length of time and actual measured length of time of the required length of time for each API are recorded.

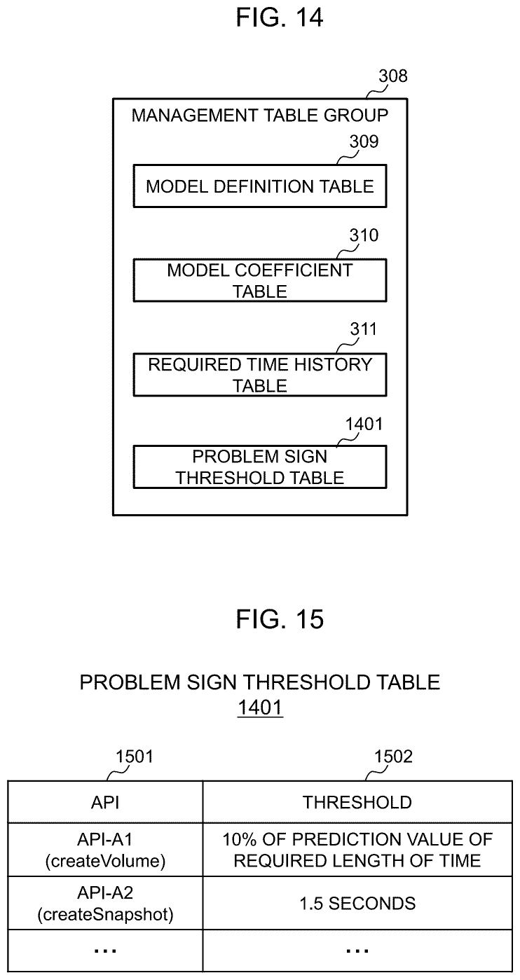

FIG. 15 illustrates an example of the problem sign threshold table 1401 according to Embodiment 2.

The problem sign threshold table 1401 has entries for each API. The entries have such information as an API name 1501 and a threshold 1502. The threshold 1502 represents the threshold for the difference between the predicted length of time and the actual measured length of time. Since the occurrence frequency of performance problems differs depending on processing contents of the API, thresholds can be set for each API. The threshold 1502 may be set as a fixed value with reference to performance problems that have occurred in the past. For APIs where the determined predicted length of time tends to vary, the threshold 1502 can be set to allow detection of problems when the time exceeds a certain percentage of the predicted length of time.

Furthermore, in Embodiment 2, when the predicted length of time is longer than the actual measured length of time by more than a certain threshold, the actual measured length of time is too short, and the processing that should actually be performed has not possibly been performed. Thus, the required time actual measurement unit 307 may check whether the processing for the requested API has been completed (not in execution). If the processing has been completed, the required time actual measurement unit 307 may perform verification processing of determining whether the configuration by the requested API has been constructed, by checking the configuration.

### Embodiment 3

Embodiment 3 is described. In this description, points different from Embodiments 1 and 2 are mainly described, while descriptions of points common to Embodiments 1 and 2 are omitted or simplified.

In Embodiment 2, regarding the execution of the API, the magnitude of the difference of the required length of time from the actual measured length of time is checked, to enable prediction of some signs of problems that have occurred, although the factor is unknown. One of the factors that make the required length of time long is that the resources for processing of changing the configuration of the storage system 101 are insufficient. In this case, the required length of time can possibly be improved through estimation of a performance insufficient resource and expansion of the insufficient resource. In Embodiment 3, it can be expected that, by using the required time history table 311, a resource that is a performance bottleneck is estimated and that resource is expanded, and the performance problem in question can be resolved.

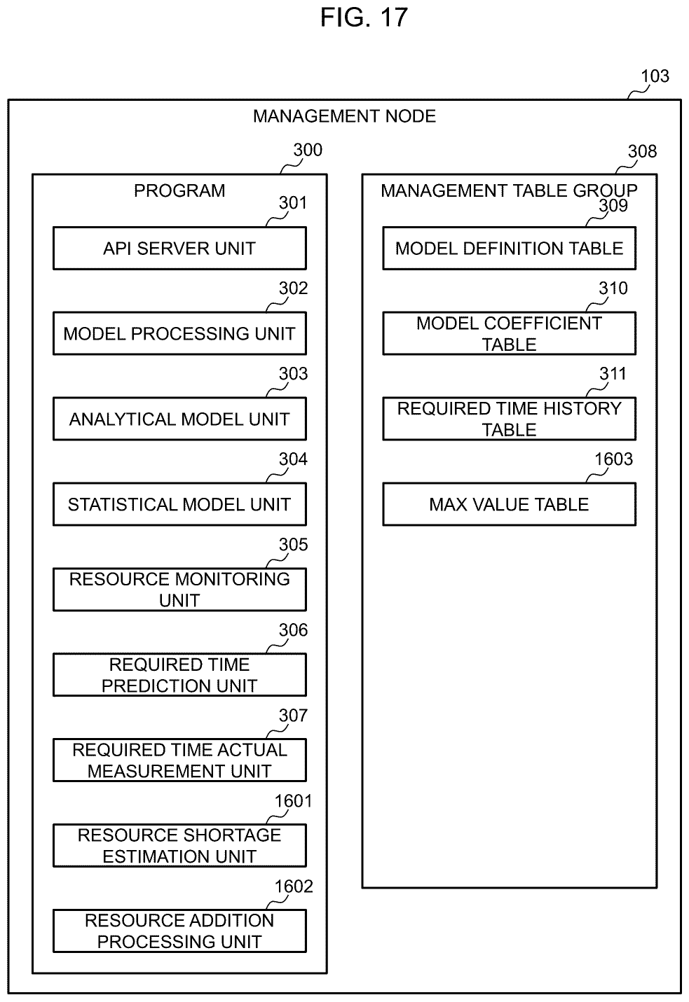

FIG. 17 illustrates examples of the configurations of the program 300 and the management table group 308 of the management node 103 according to Embodiment 3.

In the management node 103, when the program 300 is executed by the CPU 21a, in addition to the functions 301 to 307, such functions as a resource shortage estimation unit 1601 and a resource addition processing unit 1602 are implemented. Further, the management table group 308 includes, in addition to the tables 309 to 311, a MAX value table 1603.

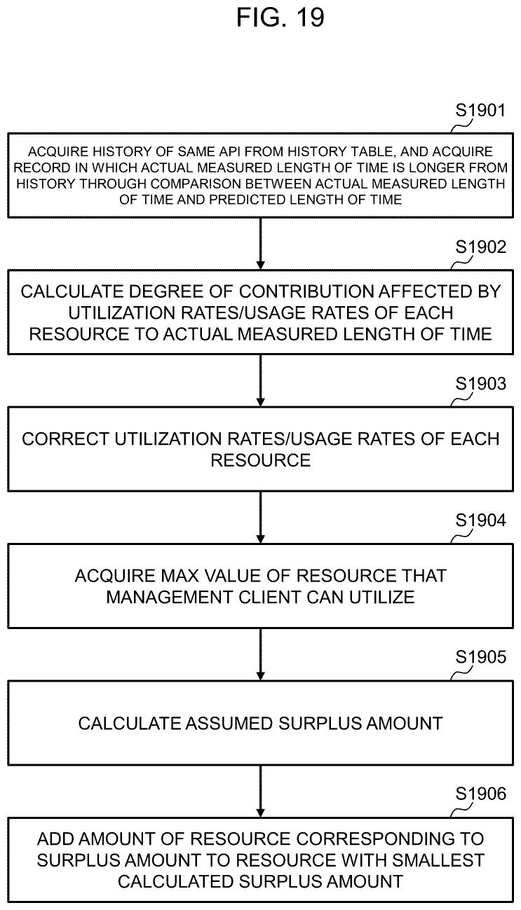

The resource shortage estimation unit 1601 estimates which resource is a bottleneck when an actual required length of time is longer than a required length of time predicted from the history table 311. The resource shortage estimation unit 1601 estimates a bottleneck resource and the amount of the resource by following the processing flow of FIG. 19. The resource addition processing unit 1602 performs processing of adding resources corresponding to the shortage amounts of resources estimated by the resource shortage estimation unit 1601. The MAX value table 1603 indicates the MAX value of the resource amounts of resources that the management client 107 can utilize among the resources of the storage system 101.

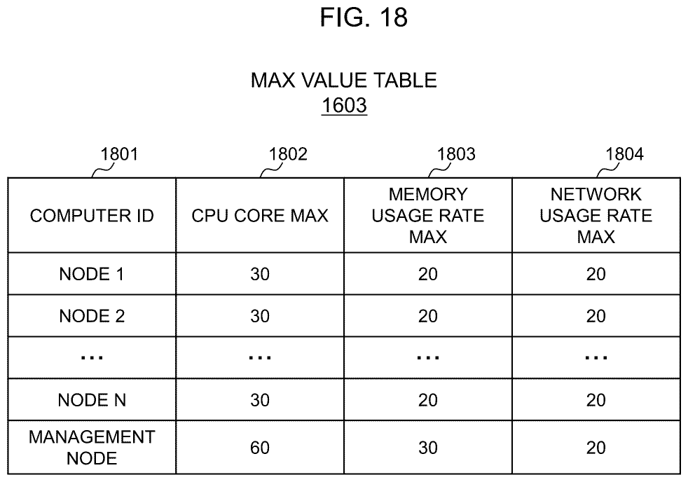

FIG. 18 illustrates an example of the MAX value table 1603 according to Embodiment 3.

The MAX value table 1603 has entries for each virtual computer. The entries have such information as a computer ID 1801, a CPU core MAX 1802, a memory usage rate MAX 1803, and a network usage rate MAX 1804.

The computer ID 1801 represents the ID of the virtual computer. The CPU core MAX 1802 represents the MAX value of the CPU utilization rate of the CPU core. The memory usage rate MAX 1803 represents the MAX value of the memory usage rate. The network usage rate MAX 1804 represents the MAX value of the network usage rate.

The resources of the storage system 101 are utilized for various purposes such as user data processing and configuration change processing. The MAX value table 1603 of usable resources can be utilized by the management client 107. That is, the MAX value table 1603 indicates the maximum values of the utilization rates/usage rates of usable resources mainly for the configuration change processing of the storage system 101. In the storage system 101, processing for requests (typically, I/O requests) from the application 106 of the host computer 105 is prioritized, and hence, restrictions are placed on resources to be utilized for requests from the management client 107 in some cases. The MAX value table 1603 is a table of the MAX values for those restrictions. If a resource has been used at a utilization rate/usage rate equal to or higher than that indicated in the MAX value table 1603 of utilizable resources, it means that the resource is insufficient.

FIG. 19 illustrates an example of a processing flow for adding an insufficient resource according to Embodiment 3.

The resource shortage estimation unit 1601 acquires records of the same API (entries with the same API_name 901) from the required time history table 311 and compares the actual measured length of time (the actual value of the required length of time) with the predicted length of time 1702, to acquire records in which the actual measured length of time is longer than the predicted length of time 1702 from the records (S1901).

The resource shortage estimation unit 1601 calculates degrees of contribution (the degrees of contribution of the impact of the utilization rates/usage rates of each resource) to the actual measured length of time (S1902). “Degree of contribution” here is the proportion of how much each resource affects the required length of time. While various methods for calculating the degrees of contribution are conceivable, the resource shortage estimation unit 1601 calculates a standardized partial regression coefficient as a degree of contribution. An example is described here, but the present invention is not limited to this technique. For example, the resource shortage estimation unit 1601 performs multiple regression analysis and calculates a standardized partial regression coefficient from the obtained partial regression coefficients. An API for volume creation is given as an example. The required length of time is set as an objective variable, and parameters specified by the API (for example, the volume size: 10 GB and the number of volumes: 50), the resource status (the CPU utilization rate, the memory usage rate, and the network usage rate) of the management node 103, and the resource status (the CPU utilization rate, the memory usage rate, and the network usage rate) of the storage node 102 are set as explanatory variables. For example, for a certain target API 108, (Equation 3) described below is constructed as the equation for a required length of time for an operation in accordance with a request for that API 108.

Required length of time=B0+B1×number of volumes+B2×volume size+B3×CPU utilization rate of storage node 102+B4×memory usage rate of storage node 102+B5×network usage rate of storage node 102+B6×CPU utilization rate of management node 103+B7×memory usage rate of management node 103+B8×network usage rate of management node 103 (Equation 3)

The resource shortage estimation unit 1601 obtains the partial regression coefficients B0 to B8 of the multiple regression analysis by the least squares method, by utilizing the records acquired in S1901. That is, the resource shortage estimation unit 1601 calculates which explanatory variables significantly affect the objective variable, which is the required length of time, for cases where the predicted length of time is longer than the actual measured length of time. Regarding the obtained partial regression coefficients B0 to B8 of the multiple regression analysis, the resource shortage estimation unit 1601 calculates each standardized partial regression coefficient with “standardized partial regression coefficient=(partial regression coefficient)×(standard deviation of explanatory variable)/(standard deviation of objective variable).” This standardized partial regression coefficient serves as the degree of contribution as to how much each explanatory variable affects the objective variable, which is the required length of time.

Next, the resource shortage estimation unit 1601 corrects the utilization rates/usage rates of each resource on the basis of the degrees of contribution calculated in S1902 (S1903). While there are various correction methods, when a case where the required length of time is even longer is assumed, the impact of the utilization rates/usage rates of resources with large degrees of contribution is even more significant. The resource shortage estimation unit 1601 uses values obtained through multiplication of the utilization rates/usage rates of the resources and the degrees of contribution thereof and normalization of the resultant, as virtual resource utilization rates/usage rates, and sets those as correction values for the utilization rates/usage rates of each resource.

Next, the resource shortage estimation unit 1601 acquires the MAX values of resources that the management client 107 can utilize among the resources of the storage system 101 from the MAX value table 1603 (S1904). The resource shortage estimation unit 1601 calculates the differences between the MAX values of the resources that the management client 107 can utilize and the utilization rates/usage rates of each resource obtained after the correction in S1903 (S1905). For each resource, the calculated difference is an estimate of the surplus amount of the resource that is assumed if the resource is used further.

The resource with the smallest surplus amount calculated in S1905 is likely to be a resource bottleneck. The resource addition processing unit 1602 detects the resource with the smallest surplus amount calculated in S1905 and adds an amount of resource corresponding to the surplus amount to the detected resource (S1906).

For example, if {storage node CPU utilization rate: 20, storage node memory usage rate: 10, storage node network usage rate: 10, management node CPU utilization rate: 40, management node memory usage rate: 20, and management node network usage rate: 10} and the degrees of contribution thereof are {10, 10, 10, 40, 20, and 10}, correction values are estimated through increases in utilization rates/usage rates by the proportions of the contribution rates. That is, if the contribution rate is 10, the utilization rate/usage rate is considered to be increased by 10% and is multiplied by 1.1. That is, correction values obtained through multiplication of {1.1, 1.1, 1.1, 1.4, 1.2, and 1.1} as proportions equivalent to the contribution rates and the utilization rates/usage rates of the resources are {22, 11, 11, 56, 24, and 11}. When these are subtracted from the MAX values of the usable resources {30, 20, 20, 60, 30, and 20} of FIGS. 18, {8, 9, 9, 4, 6, and 9} are obtained. These are the surplus amounts of the resources. The CPU utilization rate of the management node with the smallest surplus amount of “4” is considered to be likely to be a bottleneck of resource shortage.

In this manner, it is possible to detect resources that are possibly performance bottlenecks and to improve the performance through enhancement of the detected resources that are performance bottlenecks. As the resource enhancement method, widely known scale-up or scale-out techniques can be utilized. In this example, the management node 103 and the storage node 102 are virtual computers that secure resources on the cloud 100, and hence, examples of scale-up and scale-out methods for virtual computers on the cloud 100 are described. Many cloud services have a mechanism in which a plurality of types of virtual computers are provided with specified performance for each resource, such as the CPU operating frequency, the number of cores, the memory bandwidth and size, the storage type such as an HDD or an SSD, the storage size, and the network bandwidth, and the performance of the virtual computers can be changed through a selection of these types. If a resource of a computer is insufficient, scale-up is possible through a change to a computer type with a higher performance CPU or memory. In S1906, the CPU resource allocated to the management node 103 can be added. For example, when a CPU utilization rate is detected to be in a resource shortage, selected from among computer types provided by the cloud service is a computer type that includes resources, such as the memory, the storage, and the network, with equivalent specifications to the current ones but includes more CPU cores than the current resource, as compared to the current virtual computer. In cloud services, utilizing higher performance resources is generally more expensive, and hence, in S1906, minimal resource addition can be performed to keep costs down. If a computer type with a higher operating frequency is cheaper than one with more cores, a computer type with a higher operating frequency can be selected before increasing the number of cores. With this technique, a low-cost scale-up that adds only resources that are insufficient in terms of performance can be implemented.

In this example, a specific resource is insufficient, but if it is detected in S1906 that a wide variety of resources, such as the CPU, the memory, and the network, are insufficient, a scale-out technique is utilized. For example, one virtual computer of a computer type with the same specifications as the current virtual computer is added to enhance the processing capacity.

With such a method, it is possible to analyze the history of cases where the required length of time is longer than expected, to detect resource bottlenecks, and to perform resource addition for resolving the bottlenecks.

### Embodiment 4

Embodiment 4 is described. In this description, points different from Embodiments 1 to 3 are mainly described, while descriptions of points common to Embodiments 1 to 3 are omitted or simplified.

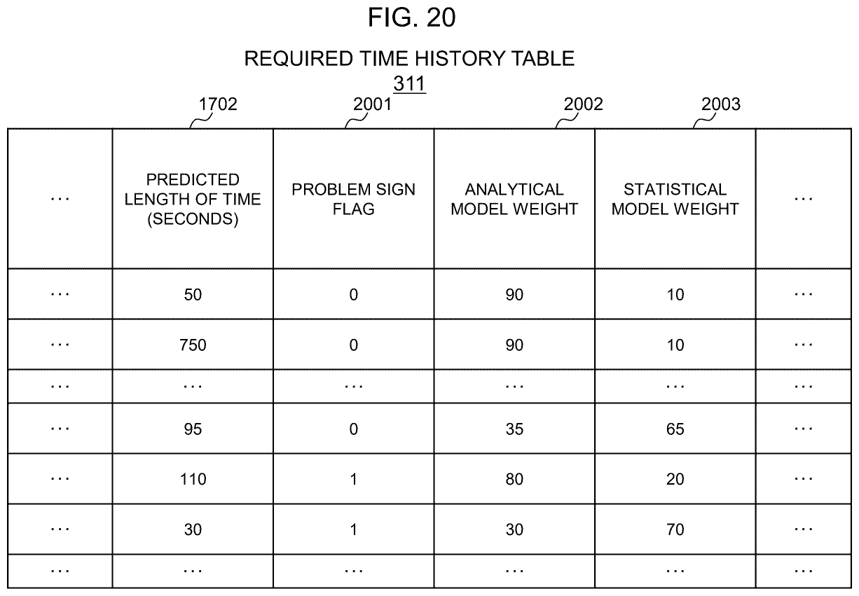

FIG. 20 illustrates an example of a part of the required time history table 311 according to Embodiment 4.

Each entry in the required time history table 311 has, in addition to the information described with reference to FIG. 17, such information as the problem sign flag 2001, an analytical model weight 2002, and a statistical model weight 2003.

The problem sign flag 2001 is a flag indicating the presence or absence of a problem sign, and “1” means there is a problem sign, and “0” means there is no problem sign.

The analytical model weight 2002 represents the weight of the analytical model, and the statistical model weight 2003 represents the weight of the statistical model. In the present embodiment, the sum of them is 100.

When the analytical model and the statistical model are used in combination, an improvement in the accuracy of a predicted length of time is expected. Calculation of a predicted length of time using the analytical model and calculation of a predicted length of time using the statistical model may be performed in parallel, and the weight of the analytical model may be reflected in the predicted length of time calculated using the analytical model, while the weight of the statistical model may be reflected in the predicted length of time calculated using the statistical model. On the basis of the predicted length of time reflecting the weight of the analytical model and the predicted length of time reflecting the weight of the statistical model, a predicted length of time (for example, the average value of the two predicted lengths of time) may be determined. Since the weight of an ideal operation (analytical model) and the weight of an actual operation (statistical model) are acquired, a reduction in the calculation cost or time for cause analysis is expected.

For example, it is assumed that the difference between the predicted length of time and the actual measured length of time is equal to or greater than a predetermined value. In this case, when the weight of the analytical model is greater than the weight of the statistical model, it can be predicted that, because a sufficient number of records have not yet been accumulated and the variance is large, the cause is possibly abrupt network delays or some time-consuming configuration information changes, and the analysis can be proceeded on the basis of this prediction. For example, it is conceivable that the difference between the predicted length of time and the actual measured length of time is equal to or greater than the predetermined value during a period of time in which the communication network 104 is congested, and hence, it is conceivable to start analysis for finding the cause of such a phenomenon from investigation of the network load in the period of time. Meanwhile, when the weight of the statistical model is greater than the weight of the analytical model, because the weight of the predicted length of time based on the statistical model is greater than that of the predicted length of time based on the analytical model, and the statistical model has a higher prediction accuracy than the analytical model, the cause is considered to be constant network delays or the like. If the actual measured length of time is longer than the predicted length of time, the cause is considered to be likely to be sudden network delays on the premise of constant network delays.

Furthermore, in the processing of estimating resources that are performance bottlenecks by use of the required time history table 311, when it is estimated which resource is a bottleneck in cases where the actual measured length of time is longer than the predicted length of time, an improvement in the accuracy of bottleneck estimation based on the weights of the models is expected. For example, when the weight of the analytical model is higher than the weight of the statistical model, if the actual measured length of time is longer than the predicted length of time, the network resource, which has been an uncertain factor at the time of design, is likely to be insufficient. Therefore, if the estimated numerical values for the CPU and the network are the same, it is possible to determine that the network resource is insufficient and to prioritize adding network resources. Meanwhile, when the weight of the statistical model is higher than the weight of the analytical model, some learning of the network environment in the field has possibly been achieved. In such cases, when insufficient resources are estimated as described above, if the resources of the CPU and the network have the same value, CPU resources can be prioritized for addition. In this manner, the weights of the analytical model and the statistical model can be used to prioritize which resources are to be added.

Several embodiments have been described above, but these are examples for describing the present invention and are not intended to limit the scope of the present invention to these embodiments only. The present invention can be implemented in various other modes.

Note that, the above description can be summarized as follows, for example. The following summary may include supplementary descriptions of the above description or descriptions of modified examples of the above-mentioned embodiments.

The management system (for example, the management node 103) includes the interface device (for example, the network I/F 21c), the storage device (for example, the memory 21b and the storage 21d), and the processor (for example, the CPU 21a) connected to the interface device and the storage device. The interface device communicates with the client (for example, the management client 107) configured to request processing for any of the plurality of APIs (for example, the APIs 108) for a management operation on the storage system (for example, the storage system 101), via the communication network. The storage device stores management data (for example, the management table group 308). The processor is connected to the interface device and the storage device.

The management data includes required time history data (for example, the required time history table 311). The required time history data is data in which, each time a management operation requested by one of the APIs is performed, a record including an actual measured length of time, which is an actual measurement value of a required length of time for the management operation, is accumulated.

The processor receives, for a target API, which is an API among the plurality of APIs for which parameters have been specified by the client, an operation request associated with the specified parameters. The processor acquires a resource load of at least a hardware resource (for example, a resource status including the utilization rate/usage rate of the resource) involved in an operation performed in response to the received operation request among the hardware resources (for example, the hardware resources 201 and/or 207) of the management system and/or the storage system. For example, the management data may include data that defines, for each API, a hardware resource (for example, a node) involved in an operation requested by the API, and from the data in question, a “hardware resource involved in an operation performed in response to the received operation request” may be identified. The processor calculates an analytical predicted length of time by inputting at least some of the specified parameters and the acquired resource load to an analytical model, which is a model of an ideal operation performed in response to the operation request for the target API, the analytical predicted length of time being a prediction value obtained by the analytical model for a required length of time for the operation performed in response to the received operation request. The processor may calculate a statistical predicted length of time by inputting the at least some of the parameters and the acquired resource load to a statistical model, which is a model constructed on the basis of statistics of history of an operation performed in response to the operation request for the target API that are included in the required time history data, the statistical predicted length of time being a prediction value obtained by the statistical model for the required length of time for the operation performed in response to the received operation request. The processor may determine a predicted length of time as a prediction value of the required length of time for the operation performed in response to the received operation request, on the basis of the analytical predicted length of time, the statistical predicted length of time, a weight of the analytical model, and a weight of the statistical model.

With this, it is possible to improve the prediction accuracy of required lengths of time for management operations to be performed in the storage system in response to operation requests made via the communication network from the API for management operations. Note that, when a first condition is satisfied (for example, when the weight of the analytical model is zero), the calculation of an analytical predicted length of time may not be performed. Further, when a second condition is satisfied (for example, when the weight of the statistical model is zero, or when a predetermined number or more of records for the target API have not been accumulated in the required time history data), the calculation of a statistical predicted length of time may not be performed. Further, analytical models and statistical models may be provided for each API, and predicted lengths of time may be calculated using the analytical model and the statistical model corresponding to a requested API. The analytical models and the statistical models for each API may be stored in the storage device. Further, for example, an example of the analytical model may be any of (Equation 1) to (Equation 3) described above.

The processor may make a prediction accuracy determination (for example, S1107), which is a determination as to whether or not a difference between the predicted length of time determined for the operation performed in response to the received operation request and an actual measured length of time of the required length of time for the operation is equal to or greater than a threshold. The processor may perform factor determination processing (for example, S1108) for the target API if a result of the prediction accuracy determination is true. The processor may make, in the factor determination processing, a factor determination (for example, S1202 and S1203), which is a determination as to whether or not the analytical model is a factor for the difference between the predicted length of time and the actual measured length of time being equal to or greater than the threshold. The processor may perform, in the factor determination processing, at least one of a correction of one of the analytical model and the statistical model and a change in the weight of at least one of the analytical model and the statistical model, depending on a result of the factor determination. With this, a further improvement in prediction accuracy is expected.

The factor determination may include performing processing, one or more times, that includes changing parameter values to be input to the analytical model from parameter values of the specified parameters, and calculating a difference between a predicted length of time calculated through input of the parameter values obtained after the change to the analytical model and an actual measured length of time of an operation corresponding to the parameter values obtained after the change, to thereby determine whether there is a change following the analytical model or not. For example, the processor may determine whether a change in difference is a change following the analytical model, by performing S1202 one or more times, and this determination may be a factor determination. With this, it is expected that the determination accuracy of whether the analytical model is a factor or not is improved, and hence, it is expected that the prediction accuracy is improved through model correction and/or weight change depending on the determination result.

The processor may correct, if a result of the factor determination is true, a model coefficient to be used in the analytical model, as a correction of the analytical model. With this, a further improvement in prediction accuracy is expected. Note that, if the result of the factor determination is true, in place of or in addition to correcting the value of the model coefficient, the processor may perform at least one of a correction other than changing the value of the model coefficient for the analytical model, changing the weight of the analytical model, and changing the weight of the statistical model for the target API. The weight change may be a change that relatively increases the weight of the analytical model and may include, for example, increasing the weight of the analytical model and/or decreasing the weight of the statistical model (the weight of the analytical model does not necessarily need to be higher than the weight of the statistical model).

The processor may relatively increase the weight of the statistical model if a result of the factor determination is false. With this, a further improvement in prediction accuracy is expected. Note that, this weight change may include, for example, decreasing the weight of the analytical model and/or increasing the weight of the statistical model (the weight of the statistical model does not necessarily need to be higher than the weight of the analytical model).

When the target API is an API with a tendency that a predicted length of time determined for the API has a certain degree or more of variation (for example, when a variation in the determined predicted length of time 1702 is equal to or greater than a certain degree), the threshold may be a value corresponding to a product of the determined predicted length of time and a ratio (for example, “10% of the prediction value of the required length of time”) defined in advance. With this, an improvement in the accuracy of prediction accuracy determination is expected.

The processor may notify, when an actual measured length of time required for the operation performed in response to the received operation request is equal to or greater than a sum of the predicted length of time determined for the operation and a predetermined threshold, the client of presence of a problem sign. With this, it is possible to enable the client to take countermeasures in advance to prevent the occurrence of problems.

After a request is made to the target API, the processor may receive a request made to a predetermined API different from the target API, may set the presence of the problem sign as a return value included in a response to that request, and may return the response to the client. In this manner, the presence of the problem sign can be notified to the client by the response to the request from the API, and hence, the implementation of notifications of the presence of problem signs is easy compared to the implementation of what is generally called push type notifications.

The processor may calculate, for each of a plurality of types of resources included in the hardware resources of the management system and/or the storage system, when an actual measured length of time required for the operation performed in response to the received operation request is equal to or greater than a sum of the predicted length of time determined for the operation and a predetermined threshold, that is, when a prediction error has occurred, a degree of contribution to the prediction error of the resource of the type, and, from the calculated degree of contribution and a load, which is an actual measurement value of the resource, a necessary resource amount (for example, a product of a value based on the degree of contribution and the resource load as an actual measurement value). The processor may estimate a resource of a type with the smallest difference between a maximum resource amount (for example, the MAX values 1802 to 1804) and the necessary resource amount, as a bottleneck resource, and may add the estimated bottleneck resource. With this, the possibility of prediction errors occurring in the future can be reduced.

The plurality of types of resources may include a processor and a network. The following may be performed when the processor and the network are estimated as the bottleneck resources. In the former case, the fact that the network resource, which has been an uncertain factor at the time of design, is likely to be insufficient is addressed. In the latter case, the fact that the processor resource is likely to be insufficient because some learning of the network environment has possibly been achieved is addressed. In this manner, the possibility of prediction errors occurring in the future can be reduced.
The processor adds a resource of the network when the weight of the analytical model is higher than the weight of the statistical model.
The processor adds a resource of the processor when the weight of the statistical model is higher than the weight of the analytical model.

The management data may include model definition data representing a defined parameter, which is a parameter defined in advance for each of the APIs as a parameter that affects a required length of time for an operation performed in response to an operation request to the API. The at least some of the parameters may include a parameter corresponding to the defined parameter corresponding to the target API. In this manner, the processor can be made to specify parameters necessary as inputs for the models for each API.

The storage system may be a system that includes one or a plurality of virtual computers being one or a plurality of storage nodes and is defined on the cloud (for example, the cloud 100), and the management system (for example, the management node 103) may be a virtual computer different from the one or plurality of storage nodes of the storage system.

1. A management system comprising:
an interface device configured to communicate with a client that requests processing for any of a plurality of application programming interfaces (APIs) for a management operation on a storage system, via a communication network;
a storage device configured to store management data; and
a processor connected to the interface device and the storage device, wherein
the management data includes required time history data,
the required time history data is data in which, each time a management operation requested by one of the APIs is performed, a record including an actual measured length of time that is an actual measurement value of a required length of time for the management operation is accumulated,
the processor is configured to
receive, for a target API that is an API among the plurality of APIs for which parameters have been specified by the client, an operation request associated with the specified parameters,
acquire a resource load of at least a hardware resource involved in an operation performed in response to the received operation request among hardware resources of the management system and/or the storage system,
calculate an analytical predicted length of time by inputting at least some of the specified parameters and the acquired resource load to an analytical model that is a model of an ideal operation performed in response to the operation request for the target API, the analytical predicted length of time being a prediction value obtained by the analytical model for a required length of time for the operation performed in response to the received operation request,
calculate a statistical predicted length of time by inputting the at least some of the parameters and the acquired resource load to a statistical model that is a model constructed on a basis of statistics of history of an operation performed in response to the operation request for the target API that are included in the required time history data, the statistical predicted length of time being a prediction value obtained by the statistical model for the required length of time for the operation performed in response to the received operation request, and
determine a predicted length of time as a prediction value of the required length of time for the operation performed in response to the received operation request, on a basis of the analytical predicted length of time, the statistical predicted length of time, a weight of the analytical model, and a weight of the statistical model.

2. The management system according to claim 1, wherein
the processor is configured to
make a prediction accuracy determination that is a determination as to whether or not a difference between the predicted length of time determined for the operation performed in response to the received operation request and an actual measured length of time of the required length of time for the operation is equal to or greater than a threshold,
perform factor determination processing for the target API if a result of the prediction accuracy determination is true,
make, in the factor determination processing, a factor determination that is a determination as to whether or not the analytical model is a factor for the difference between the predicted length of time and the actual measured length of time being equal to or greater than the threshold, and
perform, in the factor determination processing, at least one of a correction of one of the analytical model and the statistical model and a change in the weight of at least one of the analytical model and the statistical model, depending on a result of the factor determination.

3. The management system according to claim 2, wherein
the factor determination is performing processing, one or more times, that includes changing parameter values to be input to the analytical model from parameter values of the specified parameters, and calculating a difference between a predicted length of time calculated through input of the parameter values obtained after the change to the analytical model and an actual measured length of time of an operation corresponding to the parameter values obtained after the change, to thereby determine whether there is a change following the analytical model or not.

4. The management system according to claim 2, wherein
the processor corrects, if a result of the factor determination is true, a value of a model coefficient to be used in the analytical model, as a correction of the analytical model.

5. The management system according to claim 2, wherein
the processor relatively increases the weight of the statistical model if a result of the factor determination is false.

6. The management system according to claim 2, wherein,
when the target API is an API with a tendency that a predicted length of time determined for the API has a certain degree or more of variation, the threshold is a value corresponding to a product of the determined predicted length of time and a ratio defined in advance.

7. The management system according to claim 1, wherein
the processor notifies, when an actual measured length of time required for the operation performed in response to the received operation request is equal to or greater than a sum of the predicted length of time determined for the operation and a predetermined threshold, the client of presence of a problem sign.

8. The management system according to claim 7, wherein,
after a request is made to the target API, the processor receives a request made to a predetermined API different from the target API, sets the presence of the problem sign as a return value included in a response to that request, and returns the response to the client.

9. The management system according to claim 1, wherein
the processor is configured to, when an actual measured length of time required for the operation performed in response to the received operation request is equal to or greater than a sum of the predicted length of time determined for the operation and a predetermined threshold, that is, when a prediction error has occurred,
calculate, for each of a plurality of types of resources included in the hardware resources of the management system and/or the storage system, a degree of contribution to the prediction error of the resource of the type,
calculate, for each of the plurality of types of resources, a necessary resource amount from the calculated degree of contribution and a load that is an actual measurement value of the resource,
estimate a resource of a type with a smallest difference between a maximum resource amount and the necessary resource amount, as a bottleneck resource, and
add the estimated bottleneck resource.

10. The management system according to claim 9, wherein
the plurality of types of resources include a processor and a network, and
the processor is configured to, when the processor and the network are estimated as the bottleneck resources,
add a resource of the network when the weight of the analytical model is higher than the weight of the statistical model, and
add a resource of the processor when the weight of the statistical model is higher than the weight of the analytical model.

11. The management system according to claim 1, wherein
the management data includes model definition data representing a defined parameter that is a parameter defined in advance for each of the APIs as a parameter that affects a required length of time for an operation performed in response to an operation request to the API, and
the at least some of the parameters include a parameter corresponding to the defined parameter corresponding to the target API.

12. The management system according to claim 1, wherein
the storage system is a system that includes one or a plurality of virtual computers that are one or a plurality of storage nodes and is defined on a cloud, and
the management system is a virtual computer different from the one or plurality of storage nodes of the storage system.

13. A management method executed by a management system of a storage system, the management method comprising:
receiving, for a target application programming interface (API) that is an API among a plurality of APIs for a management operation on the storage system for which parameters have been specified by a client, an operation request associated with the specified parameters;
acquiring a resource load of at least a hardware resource involved in an operation performed in response to the received operation request among hardware resources of the management system and/or the storage system;
calculating an analytical predicted length of time by inputting at least some of the specified parameters and the acquired resource load to an analytical model that is a model of an ideal operation performed in response to the operation request for the target API, the analytical predicted length of time being a prediction value obtained by the analytical model for a required length of time for the operation performed in response to the received operation request;
calculating a statistical predicted length of time by inputting the at least some of the parameters and the acquired resource load to a statistical model that is a model constructed on a basis of statistics of history of an operation performed in response to the operation request for the target API that are included in required time history data in which, each time a management operation requested by one of the APIs is performed, a record including an actual measured length of time that is an actual measurement value of a required length of time for the management operation is accumulated, the statistical predicted length of time being a prediction value obtained by the statistical model for the required length of time for the operation performed in response to the received operation request; and
determining a predicted length of time as a prediction value of the required length of time for the operation performed in response to the received operation request, on a basis of the analytical predicted length of time, the statistical predicted length of time, a weight of the analytical model, and a weight of the statistical model.
